(19) United States
(12) Patent Application Publication
(10) Pub. No.: US 2003/0169999 A1
(43) Pub. Date: Sep. 11, 2003

(54) Enhanced personal video recorder architecture

(76) Inventor: Dan Kikinis, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/351,228

(22) Filed: Jan. 25, 2003

Related U.S. Application Data
(60) Provisional application No. 60/352,187, filed on Jan. 25, 2002.

(51) Int. Cl. H04N 5/76; H04N 5/781

(52) U.S. Cl. 386/46; 348/731

(57) ABSTRACT

An apparatus comprising a home video recording system that has only one central controller.

This application claims priority to provisional application No. 60/352,187 filed Jan. 25, 2002 titled “Enhanced Personal Video Recorder” (attorney docket no. 4688.P078z) and to co-pending application Ser. No. 09/875,547 filed Jun. 5, 2001 titled “Enhanced Home Entertainment System With Removable Long-Term Storage for Digital Media” (attorney docket no. 4688.P027), which claims priority to its provisional application Ser. No. 09/224,822 filed Aug. 11, 2000, (attorney docket no. 4688.P027z), all of which are incorporated herein by reference.

### BACKGROUND

The basic system components of video home entertainment systems in use today comprise a set-top box, a VCR, and a TV, all controlled by a user-operated remote control device. A simplified system diagram of a typical video recording domain is shown in FIG. 1.

In FIG. 1, TV signal 110 comes in from a source such as cable or antenna or satellite to set-top box 100, which is used to tune to the desired channel. In particular, set-top box 100 may be used to decode encoded channels, such as premier movie channels, pay-per-view channels, etc.

Set-top box 100 may typically output a channel 3 or channel 4 antenna signal to VCR 101 via connection 111. However, in some cases, this signal may be, for example, S-video, composite video, or some other type of video signal with similar capabilities and properties.

VCR 101 then drives the channel 3 or 4 signal via a radio frequency (RF) cable 112, typically, to a TV set 102. In some cases, this signal may also be S-video, composite video, or some other type of video signal with similar capabilities and properties.

Both devices (VCR 101 and set-top box 100) typically have an IR remote control input such as inputs 124 and 125, respectively. An intelligent remote controller 105, such as, for example, GemStar's VCR+, allows programming to be set up so that the set-top box tunes to a selected program at the correct time and the VCR records that program.

In other cases of prior art, the set-top box may have, for example, IR blaster output 123, which sends IR signals to a VCR (input at port 125) over link 113. Or in yet some other cases, the output plugs directly into a special remote control board, at port 123a, the alternative ending of link 113.

FIG. 2 is a simplified system diagram of the inside of a typical set-top box (STB) 100. Essentially, a set-top box has a tuning device 201 that may have also controlled access decoders for premium channels, pay-per-view channels, etc. The STB has a video output device 202 to generate a video output either from video provided by the tuning device 201 and/or in combination with video provided by the controller 203, which may include program tables, questions, viewer interaction prompts, etc.

Controller 203 may both control the functions of tuning device 201 and video output device 202 and also generate said signals for interaction with the user. Remote controller 203 in this example has an IR input 124 and an IR blaster output 123 to send control signals to a VCR, TV (not shown), etc. It may also, of course, have additional direct control buttons on the front panel, which are not shown here for reasons of simplicity and clarity.

FIG. 3 is a similarly simplified system overview diagram of a VCR device 101. Again, the VCR has a tuner device because, historically, viewers could not rely on the VCR being connected to a set-top box, so they needed to have the ability to run the VCR from an antenna system directly. The VCR has a video generation device 302 that creates the video output, and it has a controller 303 that can create certain interactive video signals, overlays, etc., for viewer interactions.

The VCR also has a recording mechanism 304, which is also controlled by said controller 303. Typically, recorder 304 records an input signal that comes from tuner device 301. (In some cases it may directly record external video, etc.) Other obvious alternatives that are within the scope of the novel art of this disclosure are not shown.) The output of recorder 304 may be made available to circuit 302 for playing back at a later time.

Controller 303 often may have some associated memory 305, such as a nonvolatile memory for programming information, so if the viewer programs the controller to record a show next week, and a power outage subsequently occurs, that programming may be retained.

Also shown in FIG. 3 are IR remote control input 125 and a physical remote control connection 123a (some consumer electronic devices have a semi-standardized control bus system that allows one remote control device to control all the remotely controlled devices of the system with a bus). Again, not shown are additional duplications of buttons for controlling the unit without the presence of a remote controller.

FIG. 4 is a high-level overview diagram of the same system illustrated in FIG. 1. TV signal 110 from an antenna or cable or satellite comes into the set-top box, which is, in this case, called the Primary Tuner (PT) 100a. PT 100a has its own controller, symbolized by a small C in the upper right hand corner. The PT then sends a signal 111 to a recording device 101a, which again has its own controller, symbolized by a small C in the upper right hand corner.

In some cases, a smart remote controller 105a, which also has its own controller C, can interact with devices 110 and 101a. So as FIG. 4 clearly shows, in a typical video recording system of prior art, there is an interaction of three intelligent units, each trying to tell the others what to do.

What is clearly needed is a home video recording system that has only one central controller, thus saving the expense and complications involved with multiple duplicative control systems trying to fight with each other.

### BRIEF DESCRIPTION OF THE DRAWINGS

FIG. 1 is a system diagram.

FIG. 2 is a system diagram according to one embodiment.

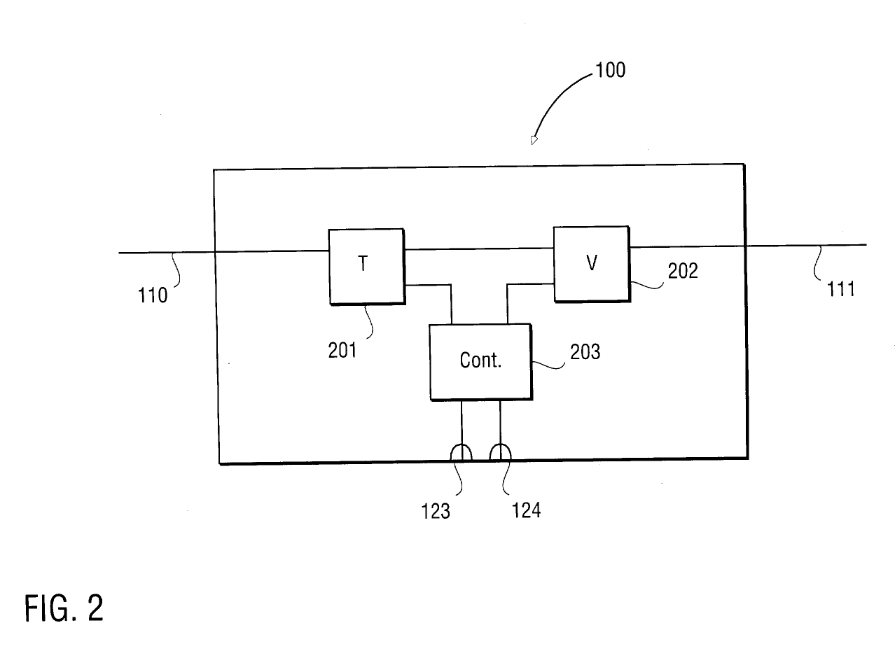

FIG. 3 is a system diagram according to one embodiment.

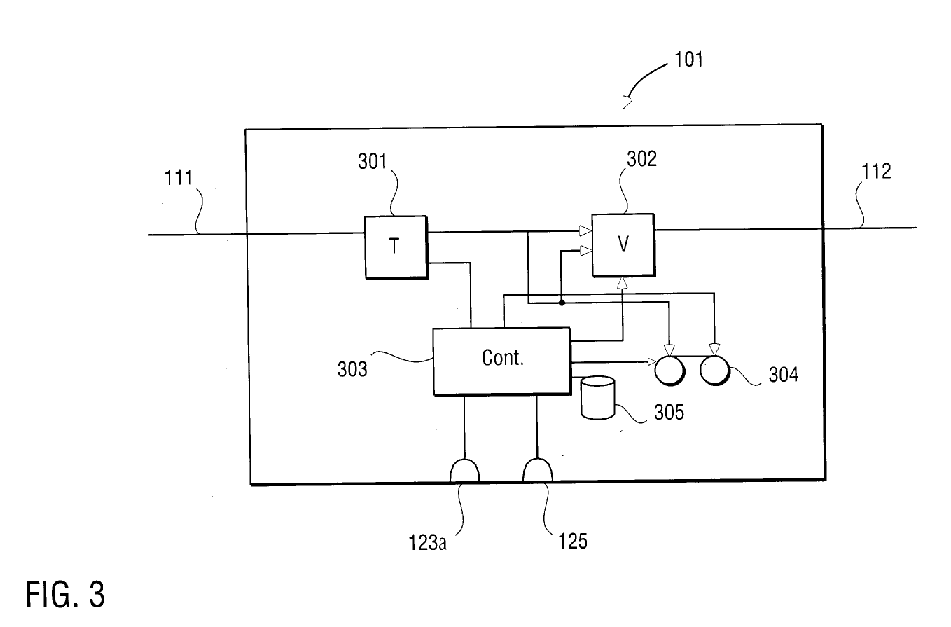

FIG. 4 is a system diagram of prior art.

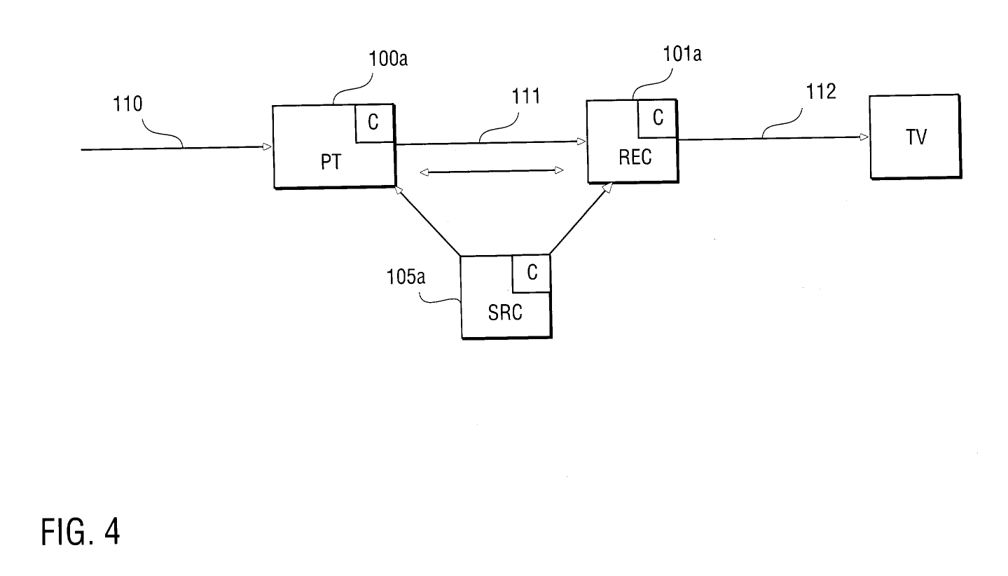

FIG. 5 is a system diagram according to one embodiment.

### DESCRIPTION OF THE EMBODIMENT

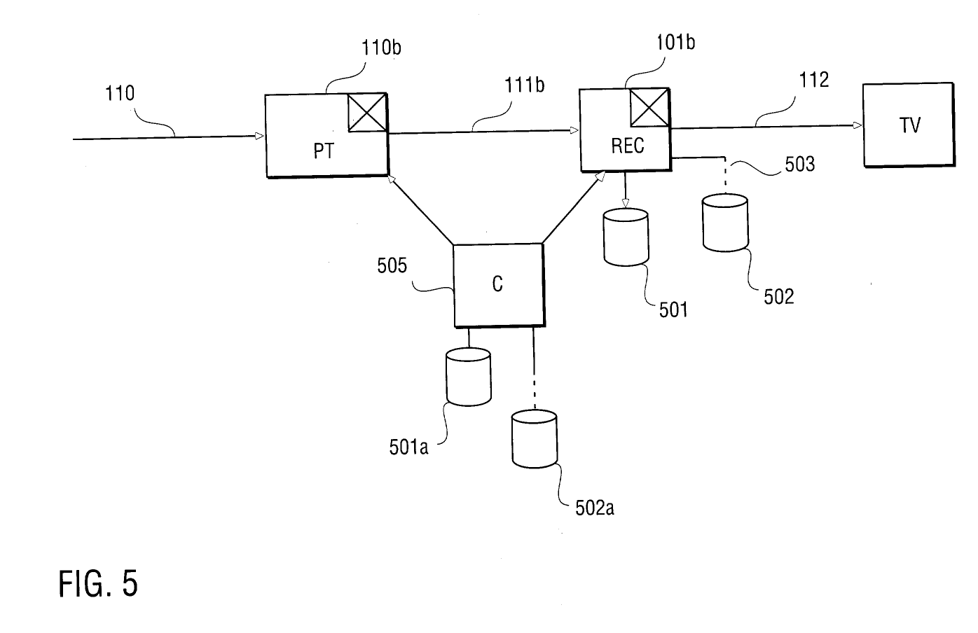

FIG. 5 is an overview diagram of a system according to the novel art of the preferred embodiment of this disclosure. Rather than having multiple control systems according to the prior art described in the Background section of this disclosure, primary tuner part 110b is controlled by controller 505, and its output is then directed to recording function 101b, which is also connected to some type of mass storage. The mass storage may be attached at the controller itself, such as mass storage device 501 a or removable storage device 502a, or it may be controlled by the recording unit itself, such as mass storage device 501 or removable storage device 502.

Signals pass through the recording device 101b from the primary tuner 110b to the TV unit. Alternatively, signals can come from one of the storage units during replay, or as output generated by the controller, for viewer interaction.

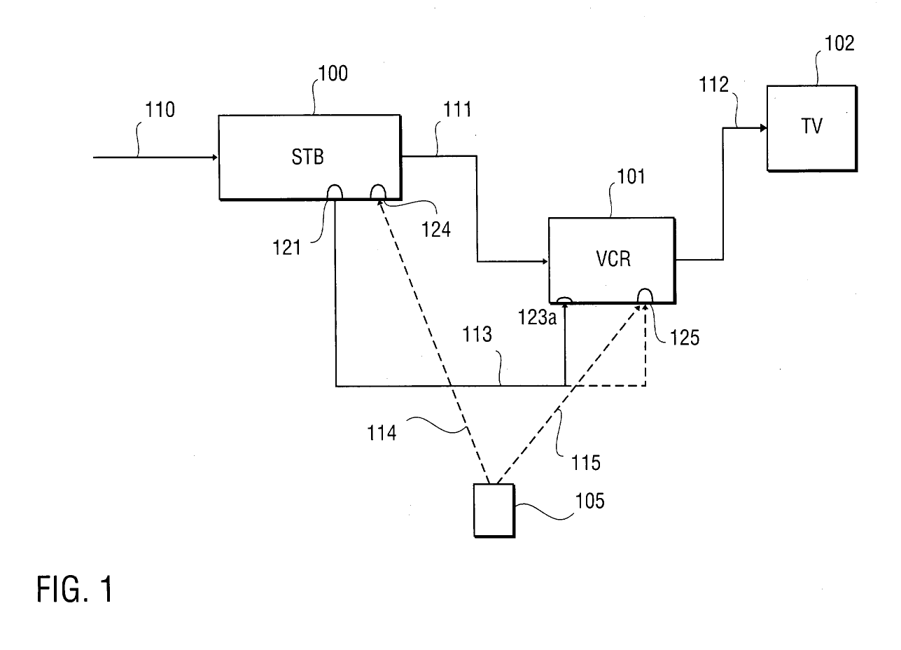

The primary storage devices 501 or 501a can also be used as storage for control information, such as data or programs. Typically the connection 111b between the primary tuning device and the recording device remains a digital video connection rather than an analog video connection, because it doesn't make sense to reconvert a digitally tuned signal. For example, in prior art the signal from a digital cable set-top box is sent as an analog signal to a VCR or PVR, even if a digital recorder such as TIVO™ or ReplayTV™ is used. Such systems currently in use send the analog video signal over link 111 in FIG. 1. In the novel art of this disclosure, it is preferable to send a digital MPEG signal directly to a hard disk (or its controller, herein referred to as a recording device), as indicated by connection 111b in FIG. 5, over which the digital video stream is sent via the controller to one of the storage devices.

Typically, these storage devices may be hard disks, but in other cases (as disclosed in iSurfTV Corporation co-pending application Ser. No. 09/875,547, which is incorporated herein by reference), they may be removable DVDs, fixed DVDs, laser disks, digital tape recorders, flash disks, holographic mass storage devices, or any other mass storage devices or nonvolatile memory devices available currently or in the future.

1) An apparatus comprising:
a home video recording system that has only one central controller.
